(19) United States
(12) Patent Application Publication
(10) Pub. No.: US 2026/0035253 A1
(43) Pub. Date: Feb. 5, 2026

(54) UNIDIRECTIONAL, INTERCONNECTED SUPER-MICROPORE SILICA SUPPORT

(71) Applicant: Trustees of Tufts College, Medford, MA (US)

(72) Inventors: Mary Jane Shultz, Medford, MA (US); Allyson MacInnis, Medford, MA (US); Rebecca Davies, Medford, MA (US); Patrick Bisson, Medford, MA (US)

(21) Appl. No.: 18/998,102

(22) PCT Filed: Jul. 25, 2023
(86) PCT No.: PCT/US2023/070983

§ 371 Date: Jan. 23, 2025

Related U.S. Application Data
(60) Provisional application No. 63/369,370, filed on Jul. 25, 2022.
(60) Provisional application No. 63/491,688, filed on Mar. 22, 2023.

(51) Int. Cl. C01B 33/148

(52) U.S. Cl. CPC C01B 33/148; C01P 2004/02; C01P 2006/16; C01P 2006/90

(57) ABSTRACT

Disclosed is a silica scaffold having unidirectional, micron-sized pores. Further disclosed is a method of making a silica scaffold in the form of a silica honeycomb monolith with unidirectional pores by freeze-casting a solution.

### CROSS-REFERENCE TO RELATED APPLICATIONS

The present application claims priority to U.S. Provisional Patent Application No. 63/369,370, filed Jul. 25, 2022, and to U.S. Provisional Patent Application No. 63/491,688, filed Mar. 22, 2023, the entire contents of which are hereby incorporated by reference.

### STATEMENT REGARDING FEDERALLY SPONSORED RESEARCH

This invention was made with government support under DE-SC0020258 awarded by the U.S. Department of Energy, CHE-1807913 awarded by the National Science Foundation, and FA9550-20-1-0351 by the Air Force Office of Scientific Research Multidisciplinary University Research Initiative. The government has certain rights in the invention.

### FIELD OF TECHNOLOGY

The disclosed technology is generally directed to porous siliceous materials. More particularly the technology is directed to porous siliceous monoliths.

### BACKGROUND

Porous siliceous materials to be used for fluid-solid flow-either liquid-solid or solid-gas—applications can be synthesized in a wide range of morphologies by various processes to provide diverse physical and chemical features. Common materials include composites, aerogels and xerogels, films and membranes, particles, and monoliths. Preparation methods can include sol-gel processing, templating methods, deposition, and a variety of other techniques. Among the reports, synthesis methods for siliceous materials targeting liquid flow applications often focus on maximizing surface area with little consideration of mechanical strength. Specifically, materials for liquid flow applications should be robust for multiple flow cycles while enabling the liquid flow.

Thus, there remains a need for porous siliceous materials designed for liquid-solid applications that have superior mechanical strength under flow processes.

### SUMMARY

Disclosed herein is a silica scaffold comprising a unidirectional, micron-pore, silica honeycomb monolith for a desired application, for example a liquid flow application. The unidirectional, micron-pore, silica honeycomb monolith has unidirectional pores having a length of at least 20 mm, a pore cross-sectional dimension of between 1 μm and 100 μm, and a pore wall thickness of between 10 nm and 1000 nm or between 1 μm and 20 μm. In some embodiments, the the unidirectional, micron-pore, silica honeycomb monolith has a Young's modulus of 300 kPa or greater, a yield strength of 100 kPa or greater, and a water-flow-through rate of 1 mL/min·cm² or greater. In other embodiments, the unidirectional, micron-pore, silica honeycomb monolith has a water-flow-through rate of 2 mL/min·cm² or greater with a constant head pressure of about 2.7 kPa. the unidirectional, micron-pore, silica honeycomb monolith when submerged in water has an optical transmittance at one or more ultraviolet or visible wavelengths of at least 0.5% or at least 5%. In other embodiments, the unidirectional, micron-pore, silica honeycomb monolith has a water-flow-through rate of 3 mL/min·cm² or greater with a constant head pressure of about 4.4 kPa. In other embodiments, the unidirectional, micron-pore, silica honeycomb monolith when submerged in water has an optical transmittance at one or more ultraviolet or visible wavelengths of at least 0.5% or at least 5%. The applications of the silica scaffold can be in liquid-solid or solid-gas flow applications. Some example applications include water remediation such as photocatalytic water purification, templated tissue growth such as filament growth, and high surface area electrodes for increased recharging rate.

In one aspect, a method of making a silica scaffold is described, which comprises the steps of freeze-casting a silicic acid solution having a pH of between 0 and 6 and a concentration of silicic acid of at least 1 M, thereby providing a freeze-casted article, and then supercritically drying the freeze-casted article, thereby providing the unidirectional, micron-pore, silica honeycomb monolith. The unidirectional, micron-pore, silica honeycomb monolith produced by this method optionally has unidirectional pores having a length of at least 20 mm up to 500 mm, a pore cross-sectional dimension of between 1 μm and 100 μm, and a pore wall thickness of between 10 nm and 1000 nm or between 1 μm and 20 μm. In one embodiment, the supercritical drying further comprises heating the soaked, freeze-casted article above a critical point of the volatile solvent. In some embodiments, the volatile solvent is ethanol.

According to an aspect, the unidirectional, micron-pore, silica honeycomb monolith has a Young's modulus of 300 kPa or greater. According to another aspect, the unidirectional, micronpore, silica honeycomb monolith has a yield strength of 100 kPa or greater. According to yet another aspect, the unidirectional, micron-pore, silica honeycomb monolith has a water-flow-through rate of 1 mL/min·cm² or greater. In another aspect, the unidirectional, micron-pore, silica honeycomb monolith has an optical transmittance at one or more ultraviolet or visible wavelengths of at least 0.5% or at least 5%.

In one embodiment, the unidirectional pores have an average cross-sectional aspect ratio of between 1:1 and 10:1. According to another embodiment, the unidirectional pores have a length of at least 1 cm. According to yet another embodiment, the pore cross-sectional dimension is between 25 μm and 75 μm.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention.

FIG. 1 shows micrographs of (a) a transverse section and (b) a longitudinal section of a frozen three-molar precursor scaffold. Regions of lighter coloration indicate the presence of ice, and darker regions indicate grain boundaries containing the silica scaffold. The semi-horizontal line in the top third of FIG. 1b is an artifact of the microtome blade used to prepare the section. Micrographs are collected at −20° C. and atmospheric pressure.

FIG. 2 shows micrographs of transverse cuts of three-molar scaffolds with various freeze front velocities to demonstrate the effect of freeze front velocity (FFV) on porous microstructure. Micrographs are shown for FFV=(a) 14.3 μm/s, (b) 18.1 μm/s, (c) 20.7 μm/s, (d) 28.0 μm/s, (e) 37.8 μm/s (f) 39.4 μm/s. With increasing FFV, the aspect ratio decreases to yield increasingly consolidated pores.

FIG. 3 shows sodium silicate oligomer size distribution by intensity from dynamic light scattering (DLS). Dynamic light scattering measurements were performed on a Malvern Zetasizer Nano-ZS (Malvern Instrument Ltd., U.K.) equipped with a He—Ne laser operating at 633 nm at 25° C. on 1 M solution. DLS measurement reveals a mixture of particles sizes, including sedimenting oligomers, present in the highly basic sodium silicate starting solution (average hydrodynamic diameter of 77 nm with 0.20 PdI). Although most silica particles have hydrodynamic diameters of 1.8±0.9 nm, a significant portion of 530±160 nm and 5.0±0.6 μm particles are also incorporated into the scaffold walls during freeze casting.

FIG. 4 shows micrographs of transverse cuts from the (a) top, (b) middle, and (c) bottom of the scaffold shown in FIG. 1, demonstrating consistent microstructure throughout the length of the scaffold. There is no correlation in the positioning of the sample between cross-sectional images.

FIG. 5 shows stress-strain curves for scaffolds of various silica concentrations. Young's modulus is the initial slope of the curve. Low concentration solutions (1 M) lead to scaffolds with very low mechanical strength. Intermediate concentration (2 M) results in a much stronger scaffold, and three-molar solutions (3 M) generate scaffold with the highest modulus. The two-molar (2 M) scaffold shows catastrophic failure below 90 kPa while the three-molar (3 M) scaffold can withstand over 200 kPa of stress (for reference, 1 atm is 101 kPa).

FIG. 6 shows scaffold transverse cut micrographs of (a) one-, (b) two-, and (c) three-molar silica concentrations. Below three-molar silica concentration, pores are inconsistent in size and shape, with many lamellar structures lacking cross-connections. Because of this lack of reproducible pore structure, average pore size measurements for one- and two-molar scaffolds are not meaningful nor reported.

FIG. 7 shows (a) a photograph of a completed scaffold after removal from SCD cell. Longitudinal micron-scale pores are visible from the dried scaffold exterior. The ruler is present as a guide to the eye; each three-molar scaffold is approximately 3.8±0.1 cm in height. FIG. 7 (b) shows a photograph of the supercritical drying cell inside a heating mantle. During SCD, input voltage is controlled, and pressure and temperature are monitored.

FIG. 8 shows (a) a photograph of stress-strain compression testing apparatus with scaffold, and (b) Measurements of silica scaffold yield strength and Young's modulus in compression as a function of concentration. Yield strengths of one-, two-, and three-molar scaffolds were 6.8±2.6, 83±13, and 215±10 kPa, respectively; Young's moduli were 22±13, 170=14, and 455±34 kPa. Reported values were averaged from three scaffold compression measurements. Each increase in silicic acid concentration yields a corresponding increase in compressive strength.

FIG. 9 shows (a) a schematic of the glass-blown fluid flow apparatus that rests atop scaffolds for flow measurement. Outlets at heights 15, 28, and 45 cm from the bottom of the tube allow for flow measurements at constant liquid heights, thus constant head pressures (1.5, 2.7, and 4.4 kPa), and (b) the average water flux through scaffolds over 100 min (1.0±0.3, 2.0±0.4, and 3.5±1.0 mL min⁻¹ cm⁻², respectively) at three flow apparatus heights. Increasing water height corresponds with increasing head pressure. The dotted line is meant as a guide to the eye. Reported values were averaged from one flow measurement at each head pressure through three different three-molar scaffolds (nine measurements total).

FIG. 10 shows water flow rate through a three-molar scaffold over 100 minutes at constant head pressure (1.47 kPa).

FIG. 11 shows a photograph of a transmittance measurement setup of He—Ne laser (633 nm) light propagating through a silica scaffold submerged in water. Percent transmittance was taken as “I/I₀” where intensity “I” is light passing perpendicularly through the cross-section of a scaffold (along the open-pore direction) soaked in water and the bottom of a beaker, and intensity “I₀” is light passing through only water and the beaker bottom before striking the thermal power sensor (MKS Ophir 30A-BB-18 thermal power sensor or a Thorlabs S130C slim Si photodiode power sensor). The area of the detector is larger than the cross-sectional area of the light sources at all wavelengths—a requirement for accurate transmittance measurements that cannot be met using highly divergent light sources, such as a UV flashlight.

FIG. 12 shows the measurements of scaffold percent transmittance in water (left column) and air (right column) at three different wavelengths through a three-molar scaffold. Transmittance was measured along the length of the pores, as incident laser radiation struck the scaffold perpendicular to the cross section. Reported values were averaged from three transmittance measurements through different areas of the same scaffold cross-section. Scaffold light transmission consistently improved in water in accordance with the smaller water-silica refractive index difference (˜Δ0.17) than silica-air (˜Δ0.5).

### DETAILED DESCRIPTION OF THE INVENTION

Disclosed herein is a silica scaffold for liquid flow applications. The methods disclosed herein provide a silica scaffold prepared by freeze-casting and supercritical drying of a sol prepared from a sodium metasilicate solution. Through freeze-casting, a robust porous structure is generated that facilitates passage of liquid. This pore scaffold morphology is desirable for moderate head pressure and long-term applications. Scaffolds generated by this method allow superior volumetric flux, head pressure and Young's modulus as compared to the state of the art. The silica scaffold as disclosed herein is translucent, therefore allowing applications utilizing visible and UV light.

Before example embodiments of an apparatus in accordance with the disclosure are described in further detail, it is to be understood that the disclosure is not limited to the particular aspects described. It is also to be understood that the terminology used herein is for the purpose of describing particular aspects only, and is not intended to be limiting. The scope of an invention described in this disclosure will be limited only by the claims. As used herein, the singular forms “a”, “an”, and “the” include plural aspects unless the context clearly dictates otherwise.

It should be apparent to those skilled in the art that many additional modifications beside those already described are possible without departing from the inventive concepts. In interpreting this disclosure, all terms should be interpreted in the broadest possible manner consistent with the context. Variations of the term “comprising”, “including” or “having” should be interpreted as referring to elements, components, or steps in a non-exclusive manner, so the referenced elements, components, or steps may be combined with other elements, components, or steps that are not expressly referenced. Aspects referenced as “comprising”, “including”, or “having” certain elements are also contemplated as “consisting essentially of” and “consisting of” those elements, unless the context clearly dictates otherwise. It should be appreciated that aspects of the disclosure that are described with respect to a system are applicable to the methods, and vice versa, unless the context explicitly dictates otherwise.

Numeric ranges disclosed herein are inclusive of their endpoints. For example, a numeric range of between 1 and 10 includes the values 1 and 10. When a series of numeric ranges are disclosed for a given value, this disclosure expressly contemplates ranges including all combinations of the upper and lower bounds of those ranges. For example, a numeric range of between 1 and 10 or between 2 and 9 is intended to include the numeric ranges of between 1 and 9 and between 2 and 10.

All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

All references, including publications, patent applications, and patents, cited herein are hereby incorporated by reference to the same extent as if each reference were individually and specifically indicated to be incorporated by reference and were set forth in its entirety herein.

Preferred aspects of this invention are described herein, including the best mode known to the inventors for carrying out the invention. Variations of those preferred aspects may become apparent to those of ordinary skill in the art upon reading the foregoing description. The inventors expect a person having ordinary skill in the art to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

Disclosed herein are porous silica scaffolds of broad utility, such as solid-gas or liquid flow applications, described in more detail below. The silica scaffolds can have a general structure in the form of a monolith. In one example, the silica monolith can be generally cylindrical with a circular or oblong cross-section. In other examples, the monolith can have a prismatic shape with a polygonal cross-section. The dimensions of the silica monolith can vary. For example, the silica monolith can have a transverse width of about 5 cm, about 10 cm, about 15 cm, about 20 cm, about 25 cm, about 30 cm, about 35 cm, about 40 cm, about 50 cm, about 55 cm, about 60 cm, about 70 cm, or about 80 cm. In another example, the height of the silica monolith (e.g., height of a cylindrical silica monolith) can be about 0.5 cm, about 1.0 cm, about 1.5 cm, about 2.0 cm, about 2.5 cm, about 3 cm, about 4 cm, or about 5 cm, or about 6 cm, or about 7 cm, or about 8 cm, or about 9 cm, or about 10 cm

### Size and Shape of Pores

Silica scaffolds for use in liquid flow applications should present low resistance to the flow. In aqueous flow for example, the required head pressure is inversely related to the diameter of the pores due to the surface tension of water. For example, a 1 mm pore presents almost no flow resistance, a 3 μm pore presents about one atmosphere resistance, while a 300 nm pore presents nearly ten atmospheres resistance.

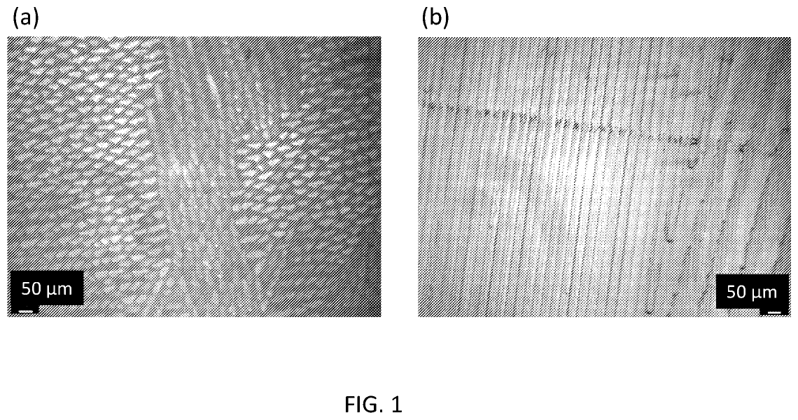

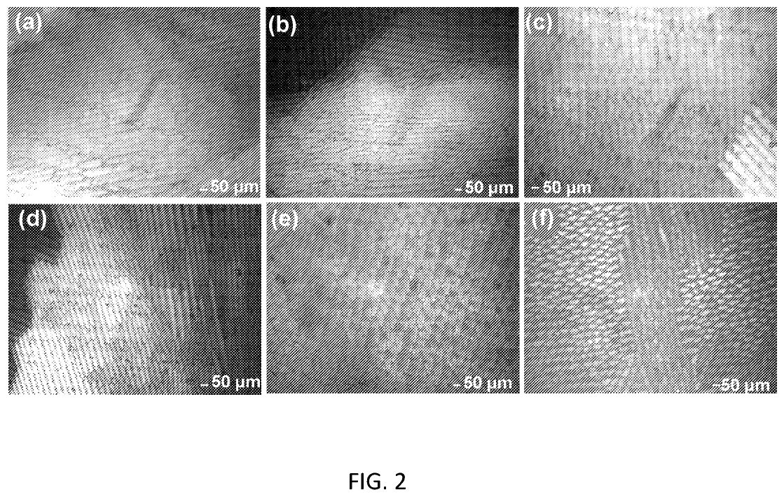

According to an aspect as disclosed herein, the silica monolith comprises a transverse honeycomb of micron-pores. Honeycomb refers to a structure having adjoining cavities. The adjoining cavities may be closely packed. The pores may be arranged hexagonally but need not be. The pores are unidirectional. As used herein, unidirectional refers to pores having a high-aspect ratio. The longitudinal directionality of the pores is such that the pores are generally parallel to one another within the silica monolith. An example of the unidirectional pores is shown in FIG. 1b. The pore size dimensions are generally homogeneous as shown in FIGS. 1, 2e and f, and 4.

The pore structures can extend between and have openings at opposing surfaces of the silica monolith. For example, the unidirectional pores can have a length of at least about 20 mm, at least about 40 mm, at least about 60 mm, at least about 80 mm or at least 100 mm, at least about 200 mm, at least about 300 mm, at least about 400 mm, at least about 500 mm, at least about 600 mm, at least about 700 mm, at least about 800 mm, at least about 900 mm, at least about 1 cm, at least about 1.1 cm, at least about 1.2 cm, or at least about 1.3 cm.

The unidirectional pores can have a substantially constant cross-sectional shape along the longitudinal length of the pore. The cross-sectional shape of the pores can be triangular, polygonal, or oblong as can be seen in FIGS. 1a, 2, and 4. In other examples the unidirectional pores can have a pore cross-sectional dimension of between 1 μm and 100 μm, between 10 μm and 100 μm, or between 25 μm and 75 μm.

Thin pore walls, for example, walls with a thickness of less than 1 μm, can reduce weight and overall bulk of the silica scaffold. According to an aspect of the disclosure, the unidirectional pore wall thickness can be between 10 nm and 1000 nm, between 50 nm and 1000 nm. In another example, the pore wall thickness can be between 1 μm and 20 μm.

The unidirectional pores in a transverse plane can have an average cross-sectional aspect ratio of between 1:1 and 10:1. In some examples, the unidirectional pores can have an average cross-sectional aspect ratio of between 1:1 and 9:1, of between 1:1 and 8:1, of between 1:1 and 7:1, of between 1:1 and 6:1, of between 1:1 and 5:1, between 2:1 and 8:1, of between 2:1 and 7:1, of between 2:1 and 6:1, or of between 2:1 and 5:1.

The unidirectional pores can be interconnected within the silica monolith. The connection of the unidirectional pores can provide interpore structures and super-micropore structures. The unidirectional pores can be interconnected yet substantially parallel such that a fluid path extends between pore openings at opposing surfaces of the silica monolith. The super-micropore structures can have lengths between 1 mm and 100 mm, 1 mm and 90 mm, 1 mm and 80 mm, or 1 mm and 70 mm, 1 mm and 60 mm, or 1 mm and 50 mm.

### Mechanical Strength Properties

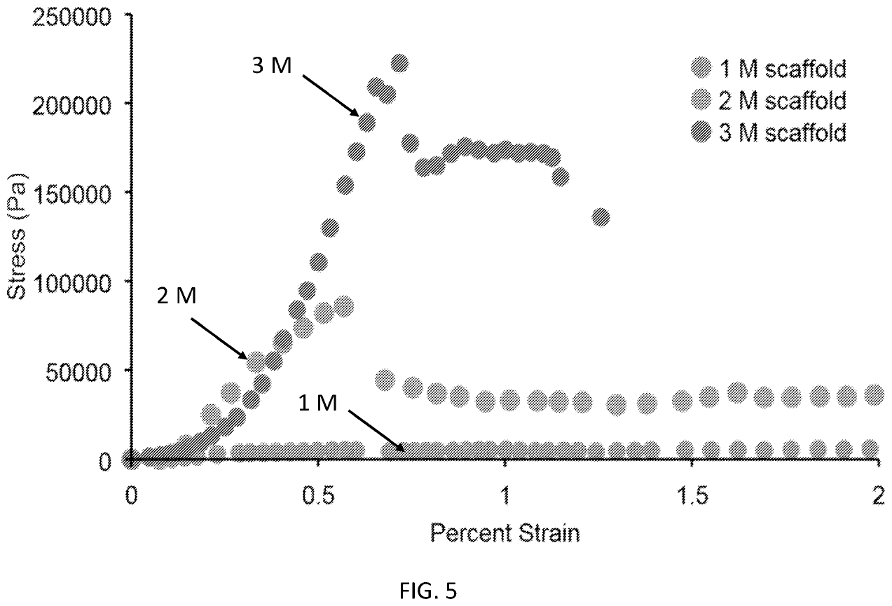

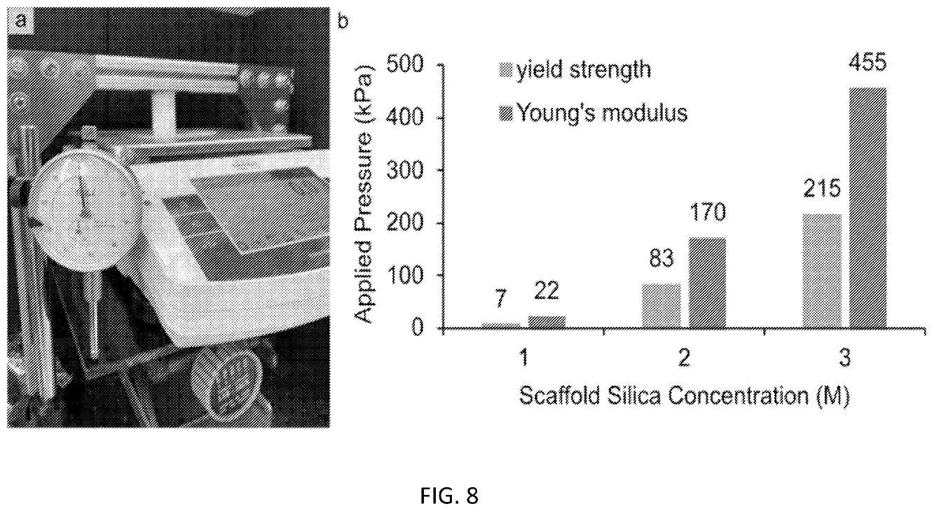

For either continuous use or batch use, the silica scaffold should be mechanically sound with regard to deformation, stress, and strain. In some examples where 3 M silicic acid is used to generate the silica monolith, the silica monolith can have a Young's modulus of about 300 kPa or greater, about 350 kPa or greater, about 400 kPa or greater, about 450 kPa or greater, or about 500 kPa or greater. The monolith can have a yield strength of about 100 kPa or greater, about 150 kPa or greater, about 200 kPa or greater, or about 215 kPa or greater. Stress and strain measurements of three exemplary silica monoliths are shown in FIGS. 5 and 8.

### Flow-Through Rate and Head Pressure

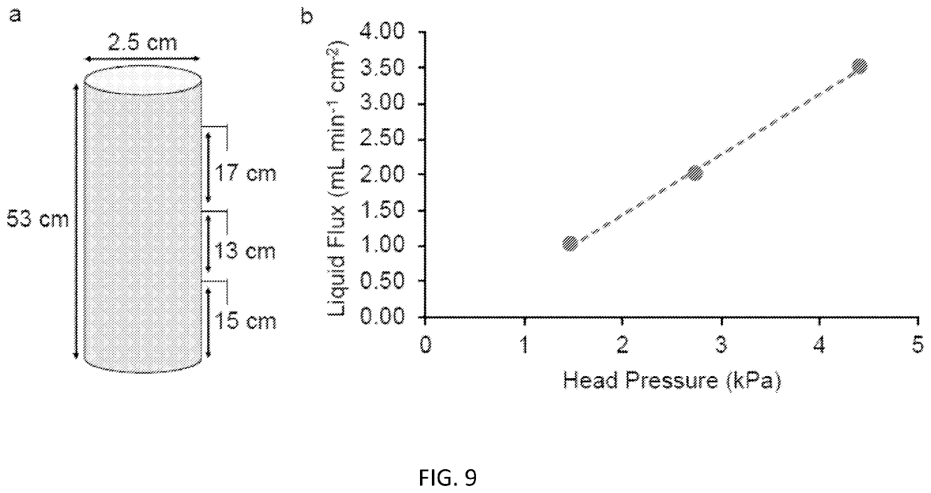

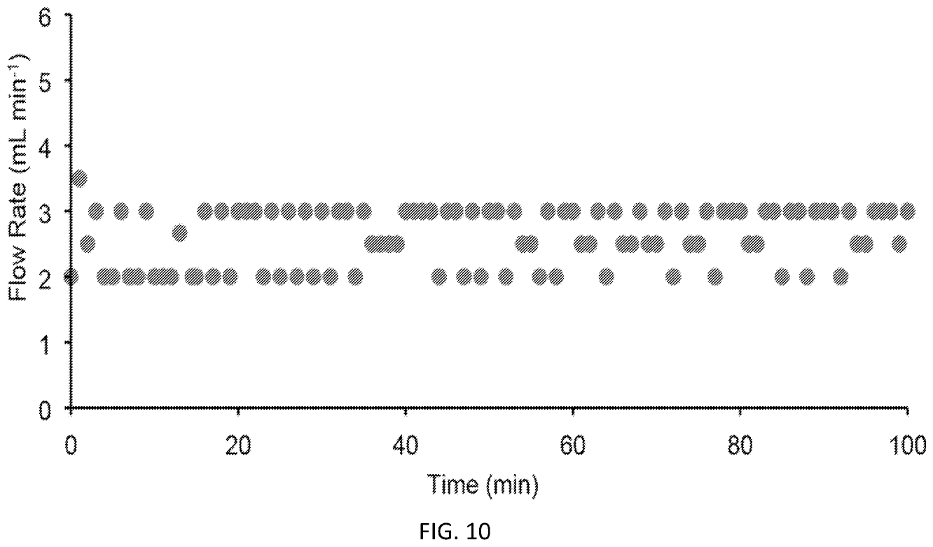

As mentioned above, the silica monoliths should present low resistance to uniaxial liquid flow that is stable over time. The silica monolith as disclosed herein can have a water-flow-through rate, or the rate at which water passes through the silica monolith. In some examples where 3 M silicic acid is used to generate the silica monolith, the water-flow-through-rate of the silica monolith can be 1 mL/min·cm² or greater. In another example, the silica monolith can have a water-flow-through rate of 1 mL/min·cm² or greater with a constant head pressure of about 1.5 kPa. In another example, the silica monolith can have a water-flow-through rate of 2 mL/min·cm² or greater with a constant head pressure of about 2.7 kPa. In still another example, the monolith can have a water-flow-through rate of 3 mL/min·cm² or greater with a constant head pressure of about 4.4 kPa. In some examples, the water-flow-through rate can be up to 100 mL/min·cm², up to 200 mL/min·cm², up to 400 mL/min·cm², up to 600 mL/min·cm², up to 800 mL/min·cm²,up to 1000 mL/min·cm² or greater. The constant head pressure can be about 10 kPa, about 20 kPa, about 40 kPa, about 60 kPa, about 80 kPa, or about 101 kPa. FIG. 9 shows an example of the variation of liquid flux with head pressure for the silica monolith as disclosed herein. The water-flow-through rate can be substantially constant for up to 20 min, up to 40 min, up to 60 min, up to 80 min, up to 100 min, or up to 200 min. FIG. 10 shows the stability of liquid flow over time through the silica monolith as disclosed herein.

### Optical Transmittance

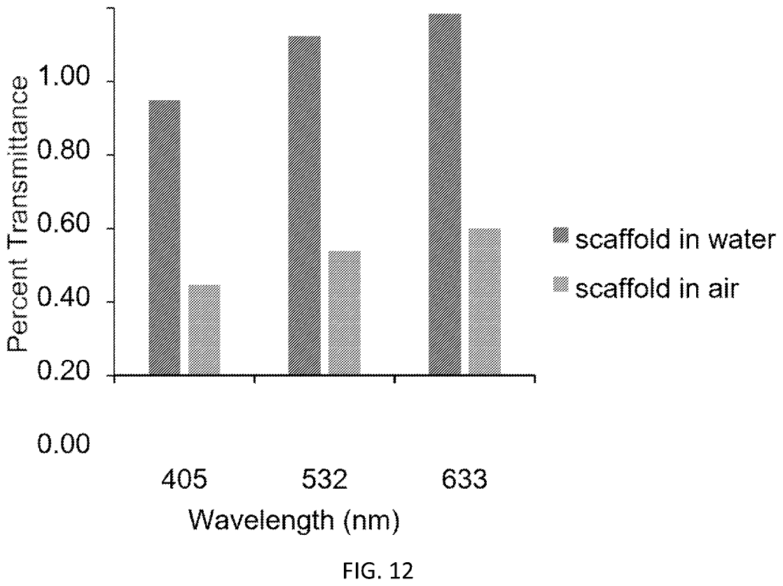

The translucency of silica can be useful in applications where are a chemical process or moiety is activated by visible or UV light, for example, a chemical process or chemical moiety located within the pores or on the walls of the silica monolith. In one example shown in FIG. 12, the silica monolith when submerged in water has an optical transmittance at one or more ultraviolet or visible wavelengths of at least 0.5%, at least 1%, at least 2%, at least 3%, at least 4%, or at least 5%. In some examples, the silica monolith when submerged in water has an optical transmittance at one or more ultraviolet or visible wavelengths of at least 10%, at least 20%, at least 30%, at least 40%, at least 50%, at least 60%, at least 70%, at least 80%, at least 90%, at least 95%, or at least 99%. In some examples, the silica monolith when in air has an optical transmittance at one or more ultraviolet or visible wavelengths of at least 0.4%, at least 0.5%, at least 0.6%, at least 1%, at least 5%, at least 10%, at least 20%, at least 30%, at least 40%, at least 50%, at least 60%, at least 70%, at least 80%, at least 90%, at least 95%, or at least 99%.

### Process

A method of making a silica monolith is disclosed. An aqueous silicic acid solution can be used as the source of silicon to form the silica monolith. The silicic acid solution can be prepared such that the solution has a pH of between 0 and 6. Sodium ions can be removed from the silicic acid solution. The concentration of silicic acid can be at least 0.5M, at least 1 M, at least 2 M, at least 2.1 M, at least 2.5 M, at least 3 M, at least 3.5M, at least 4 M, at least 4.5M or at least 5M.

An appropriate volume of the silicic acid solution can be placed in an interior cavity of a mold for freeze-casting. The size and shape of the cavity determines the general size and shape of the resulting silica monolith. In one example, the mold can include a metal plug, where exposing the metal plug to a low temperature results in directional freezing of the mold contents to produce a freeze-casted article. The low temperature can be, for example, about −78° C., about −89° C., about −102° C., about −148° C., or about −196° C. The pore size in the silica monolith can be dependent on the freeze-cast temperature as shown in Table 1. After freeze-casting, there can be an aging period in a −20° C. freezer that allows silicic acid to convert to silica. For example, acid-catalyzed condensation can facilitate formation of silica walls with both closed and continuous anisotropic pores.

Once removed from the mold, the freeze-casted article contains residual solvent. This residual solvent can be removed from the freeze-cast article by drying. Exemplary methods of drying are air-drying, lyophilization, oven-baking (calcination), or supercritical drying.

In one example, supercritical drying of the freeze-casted article can be accomplished by submerging the freeze-casted article in a volatile solvent for a predetermined soaking length of time, thereby providing a soaked, freeze-casted article. The freeze-casted article can be submerged and soaked repeatedly in fresh volatile solvent. Thus, ice is removed from the freeze-casted article via melting and replacement with volatile solvent, three times. The volatile solvent can be ethanol, methanol or acetone.

The temperature of the soaked, freeze-casted article can be raised above a critical point of the volatile solvent to remove all remaining solvents. The critical point is the highest temperature at which the solvent can exist in vapor/liquid equilibrium. At temperatures higher than the critical temperature, the solvent cannot exist as a liquid no matter the pressure. Under these conditions, the volatile solvent and residual solvent evaporate when pressure is released.

Supercritical drying of the soaked, freeze-casted article provides the silica monolith. As described above, the silica monolith produced by this method has unidirectional pores. As described above, the unidirectional pores can each have a length of at least 20 mm or at least 1 cm. The unidirectional pores can each have a pore cross-sectional dimension of between 1 μm and 100 μm.

This process as disclosed herein leverages properties of ice growth via freeze-casting to create the disclosed silica scaffold with advantageous pore structure and robust mechanical properties. The silica scaffold and process as disclosed herein include reproducible pore sizes, robust mechanical strength superior to other silica-based materials, and high flow rates.

### EXAMPLES

### Example 1

### Introduction

Meso- and macroporous^{1,2} siliceous materials have been studied extensively for use in diverse applications for over 20 years. They show promise in areas as diverse as heterogeneous catalysis,^{3,4} energy storage,⁵ adsorption and separations,⁶⁻⁸ and biomedical devices.⁹⁻¹¹ These siliceous materials are synthesized in a wide range of morphologies and by several processes to meet the diverse physical and chemical requirements of these applications. Common materials include composites,^{4-6,12,13} aerogels and xerogels,^{8,10,14,15} films and membranes,^{7,16} particles,¹⁷ and microstructured monoliths.^{3,18-20} Preparation methods include sol-gel processing,^{3,14,21} templating methods,^{4,8,10,19,20,22} deposition,⁷ and a variety of other techniques.

Among the reported siliceous materials,²² most target solid-gas applications such as heterogeneous catalysis or adsorption. Synthesis methods for materials targeting solid-gas applications often focus on maximizing surface area with little consideration of mechanical strength. In contrast, liquid flow applications favor micron-scale pores to reduce head pressure requirements resulting from Laplace pressure and good mechanical strength for robustness through multiple flow cycles. Of monoliths reported for liquid-phase applications, most include organic linkages integral to maintaining monolith structure.^{2,3,10,12,13,16,18,23-26} In many applications, a purely inorganic scaffold may be preferable for resistance to corrosion or catalytic degradation.

This contribution describes a mechanically robust, degradation-resistant, highly reproducible, and anisotropically macroporous silica scaffold for liquid flow applications. This ordered silica monolith is prepared by freeze-casting and supercritical drying of a sol prepared from commercially available sodium metasilicate solution. The purely inorganic backbone prevents degradation that may result from unintended reaction with adsorbed moieties. Through freeze-casting, 65 μm×30 μm diameter pores with approximately 10 μm thick walls are generated, creating a large deposition-area-to-volume ratio while allowing passage of significant liquid volumes with low head pressure. This large pore scaffold morphology is desirable for low energy consumption, moderate head pressure, and long-term applications. Due to the high surface tension (γ) of water, ideal pore sizes for low-pressure aqueous flow exceed 10 microns. Per the Laplace-Young equation,²⁷ pores on the order of 10-100 μm diameter (5-50 μm radii, R) correspond to pressures (p) of 0.3 to 0.03 atm for water:

$$Δ p = - γ ( \frac{1}{{R}_{1}} + \frac{1}{{R}_{2}} ) \qquad ( 1 )$$

Scaffolds generated by this method allow 3.5±1.0 mL min⁻¹ cm⁻² volumetric flux at 4.4 kPa head pressure and have a Young's modulus of 455±34 kPa in compression. The translucency of the silica scaffold lends itself to applications where adsorbed moieties are activated by visible and UV light.

### Experimental Section

### Scaffold Synthesis

One-molar sodium metasilicate solution (50 mL, Sigma-Aldrich) was run through a column containing Amberlite IR120 hydrogen form ion exchange resin (125 mL, Supelco). Low-pH (1-2) silicic acid solution effluent (50 mL) was rotary evaporated to a three-molar concentration. The concentrated, low-pH effluent was poured into a cylindrical Teflon mold (2.54 cm. I.D.×5.08 cm height) with a copper plug bottom, and the copper plug was dipped directly into liquid nitrogen to freeze unidirectionally, or freeze-cast, until solidified. Liquid nitrogen was manually replenished to maintain copper plug contact with the liquid nitrogen surface for the duration of the freeze-cast. The frozen scaffold was moved to a −20° C. freezer for 24 h.

### Microscopy

Transverse and longitudinal scaffold sections were saw-cut, microtomed, and slide-mounted in the frozen state. Images were collected using a Meiji compound microscope (4× objective) and PixeLINK PL-A662 Megapixel FireWire Camera (mounted atop the 0.7× magnification photo tube). Average grain size was analyzed using ImageJ and calibrated scale bars.

### Supercritical Drying

Frozen scaffolds were submerged in 100 mL of room-temperature ethanol for 24 h, and the ethanol was exchanged twice more for 24 h each. The ethanol-exchanged scaffold was loaded into a custom SCD (supercritical drying) cell with 70 mL of ethanol and sealed. The cell was heated and held above the critical point of ethanol (241° C., 62.2 atm) for 5 min. Pressure was vented over 2 min, and the cell cooled to room temperature.

### Uniaxial Strain

A uniaxial stress-strain apparatus was constructed according to Genov's description.²⁷ Supercritically dried scaffolds of known dimensions were placed atop a Radwag WLC X2 Precision Balance (20 kg max) or an Accuteck A-BC200 Digital Scale (98 kg max), and the balance was zeroed. The lab jack and plate supporting the scale were raised until touching the pin of the Teclock drop dial indicator and mass registered on the balance. Mass was recorded as a function of displacement until the scaffold fractured.

### Flow

A flow apparatus was glass-blown from a 2.54 cm diameter glass tube with overflow ports at various heights (15, 28, and 45 cm) from the top of the scaffold applying head pressure to the scaffold. Three-molar scaffolds were heat-shrink-wrapped to the bottom of the flow apparatus, allowing longitudinal liquid flow. In this example, the flow is from top to bottom, driven by the force of gravity. Two overflow ports were plugged, so one head pressure was probed at a time. Reserve water was added continuously to the apparatus as water flowed through the scaffold and out of the unplugged overflow port, maintaining a constant head pressure throughout flow characterization. Effluent volumes were recorded as a function of time.

### Results

### Freeze-Casting and Supercritical Drying

During freeze-casting, solidifying water sweeps solutes to the grain boundaries, generating a silica scaffold precursor. During aging, acid-catalyzed condensation consolidates silica walls, giving rise to closed and continuous anisotropic pores (FIG. 1).^{2,28} The choice of sodium silicate starting material ensures inexpensive manufacture of scaffolds resistant to corrosion and UV degradation. An ion exchange resin was utilized to both lower pH and remove sodium cations which act as flocculating agents, causing premature gelation.²⁹

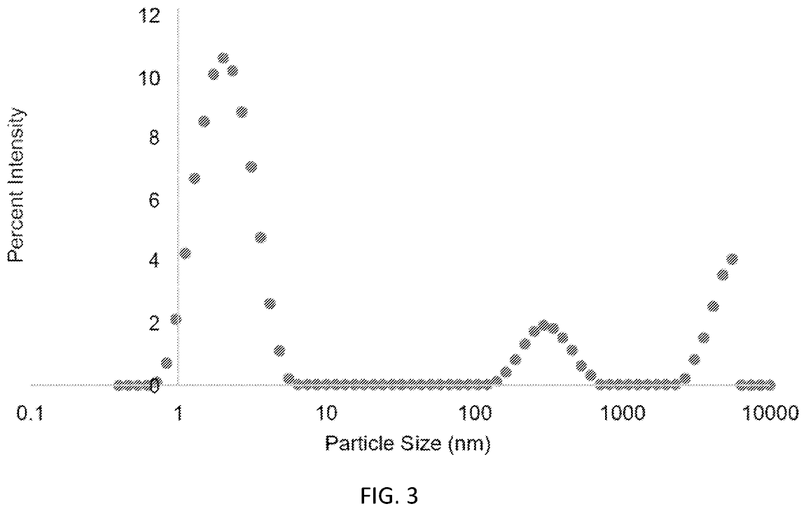

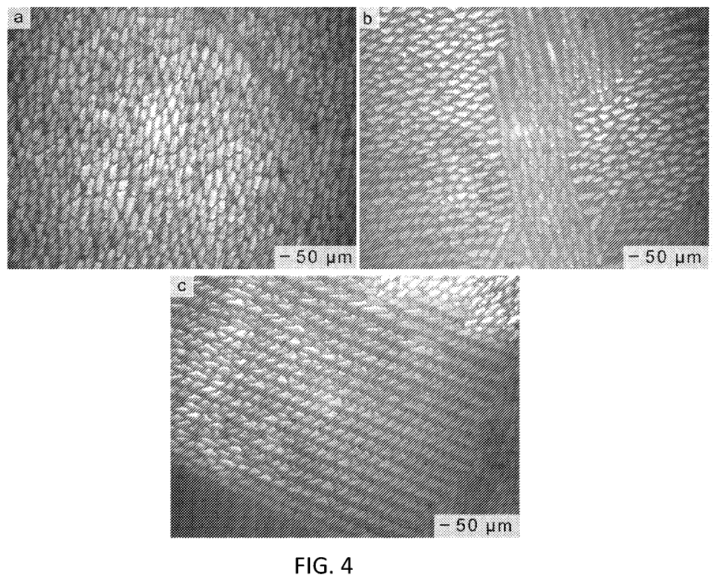

Grain size measurements reveal average pore cross-sectional widths of 55-75 μm by 25-35 μm: an aspect ratio of approximately 2:1. Average pore size is controlled by adjusting the freeze-cast temperature (Table 1 and FIG. 2).^{20,30} Freezing at −196° C. prevents settling of silicic acid oligomers (FIG. 3) during the freeze-cast, yielding highly reproducible pore structures, both longitudinally and transversely. Pore cross section (FIG. 4) remains consistent along the entire height of the sample (approximately 3.8±0.1 cm).

TABLE 1
Impact of freeze front velocity (FFV) on pore size and
aspect ratio. AEM #nn refers to three-molar silica
scaffold sample number. Decreasing freeze temperature
yields faster FFV and decreasing aspect ratio.

| | Average | | Average | Average | |
|---|---|---|---|---|---|
| | Freeze | Freeze | Pore Size | Pore Size | |
| | Stage | Front | (shorter | (longer | Aspect |
| | Temperature | Velocity | axis) | axis) | Ratio |
| Sample* | ° C. | μm/s | μm | μm | short:long |
| AEM #14 | −78.6 ± 2.1 | 14.3 | 36 ± 13 | 138 ± 106 | 1:3.8 |
| AEM #15 | −89.2 ± 6.4 | 18.1 | 27 ± 7 | 122 ± 101 | 1:4.5 |
| AEM #17 | −102.2 ± 4.6 | 20.7 | 37 ± 7 | 98 ± 48 | 1:2.6 |
| AEM #18 | −148.7 ± 3.5 | 28.0 | 16 ± 6 | 46 ± 45 | 1:2.9 |
| AEM #20 | −196.0** | 37.8 | 32 ± 7 | 74 ± 16 | 1:2.3 |
| AEM #22 | −196.0** | 39.4 | 23 ± 6 | 50 ± 14 | 1:2.2 |

(**microscope images taken in the frozen state, transverse cuts were used to determine average pore size)
(**directly liquid nitrogen dipped)

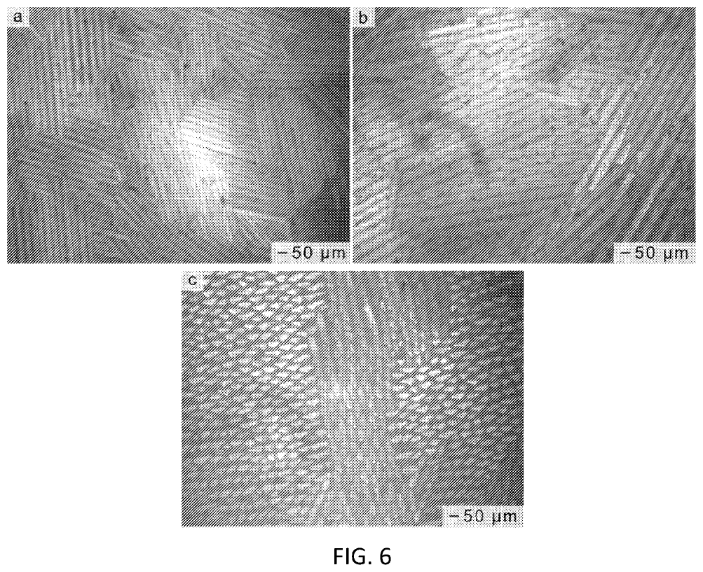

To optimize scaffold strength, scaffolds with one-, two-, and three-molar silicic acid concentrations were synthesized and subjected to compression measurement (FIG. 5). Consistently, frozen-state scaffold cross sections (FIG. 6) reveal that fully consolidated walls are observed at the three-molar concentration. Below three-molar, the scaffold shows many lamellar structures, lacking cross-connections.

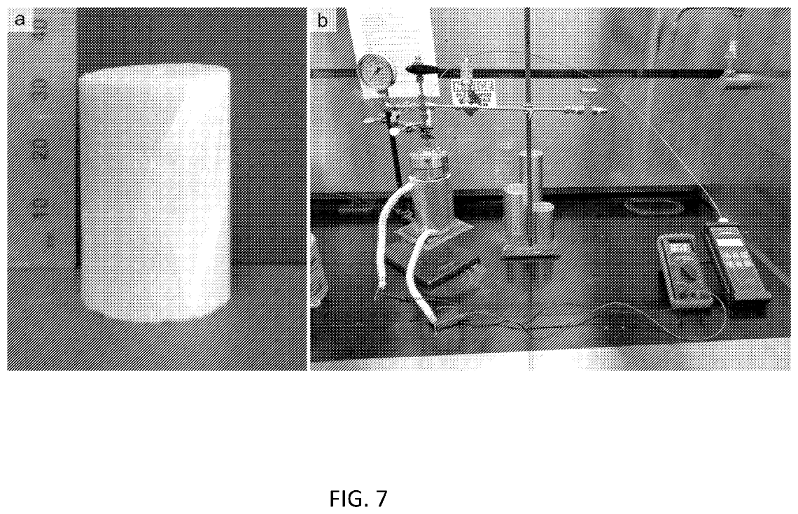

Supercritical drying (SCD) was used to remove water without damaging the scaffold pore structure, transforming scaffolds from the frozen state to a dry, usable product (FIG. 7a). The SCD cell is shown in FIG. 7b. When supercritically drying scaffolds, ethanol is used as the solvent; it has a much lower surface tension (22.32 mN/m) than does water (72 mN/m), thus putting less strain on the nascent scaffold. Additionally, supercritical conditions for ethanol are milder than those for water. Keeping ethanol above its critical point, venting pressure at high temperature, and lowering temperature allows the scaffold to avoid a harsh liquid-to-gas phase transition. This preserves the pore structure and minimizes shrinkage in contrast to calcination, which collapses pores.³¹ Supercritical drying offers a significant increase in compressive strength of scaffolds compared to lyophilization and air-drying.

### Strength Measurement

Once dried, scaffolds at each concentration were subjected to uniaxial compressive measurements. Young's modulus and yield strength increased with each silicic acid concentration increase from one- to three-molar starting material (FIGS. 5 and 8). Under uniaxial compressive stress, the three-molar scaffold has a superior average Young's modulus of 455±34 kPa and yield strength of 215±10 kPa.

### Liquid Flow Measurement

Liquid flows uniaxially through the scaffold's highly anisotropic pores. Using a simple apparatus (FIG. 9a), flow characteristics of the finished three-molar product were probed at constant head pressures. A volumetric flux of water of 3.5±1.0 mL min⁻¹ cm⁻² at 4.4 kPa head pressure was maintained for over 100 min without observable compromise of pore structure (FIGS. 9b and 10).

### Discussion

### Highly Consolidated Walls

Combining freeze-casting with conventional sol-gel chemistry provides ideal pore morphologies for moderate-pressure, aqueous liquid flow applications.^{4,19,20} Shown in the cross-sectional micrograph (FIG. 1a), scaffold pores are closed polygons in two dimensions. The longitudinal section micrograph (FIG. 1b) reveals a large channel length-to-diameter ratio. The consistent top-to-bottom microstructure of the third dimension of most pores means that the liquid entering a pore at the top of the scaffold likely exits via that same pore; in this way, the silica scaffold resembles a bundle of straws. Transverse section micrographs from the top, middle, and bottom of the same scaffold (FIG. 4) corroborate the claim that pores remain consistent along the entire height of the sample, marking a key advancement relative to previously reported monoliths. Scaffolds prepared by this method can be utilized top-to-bottom without sacrificing material due to non-steady-state freezing. Here, it is shown that a three-molar solution and fast freezing generate uniform, straight pores.

Below three-molar concentration, the scaffold shows lamellar structures (FIG. 6), lacking cross-connections. Lack of cross-connections limits mechanical strength (FIG. 8). The large aspect ratio of the pore diameters of one- and two-molar samples indicates there was not enough silicic acid in solution to form smaller, more regular pores like those observed in the three-molar cross section. Wall volume calculations assuming the observed 10 μm pore wall thickness and 30 μm×65 μm pore openings indicate that three-molar starting material provides sufficient silica monomer volume to yield consolidated scaffold walls. By this estimate, a two-molar starting material concentration would yield unconsolidated walls, as evidenced by the larger-perimeter two-dimensional pores in FIG. 6. In aqueous applications, the three-molar, tens-of-microns-sized pores provide a suitable balance between maintaining high-deposition-area-to-volume ratio required of a substrate for functionalization and mitigating high Laplace pressure generated by surface tension.^{23,32}

### Drying Method

The scaffold drying method was selected for improved scaffold strength and pore morphology. Air-drying and lyophilization provided negligible strength and yielded un-handleable, disintegrating scaffolds. Leaving water in the scaffold and lyophilizing resulted in significant distortion, shrinkage, and inferior mechanical strength as water surface tension pulled smaller pores together. Oven-baking (calcination) at temperatures 300-800° C. provided significant strength yet caused considerable scaffold shrinkage, making scaffolds unusable. Supercritical drying (SCD) was chosen (FIG. 7) as a well-suited compromise to protect the morphology imparted via freeze-casting while increasing mechanical strength. Compared to lyophilization, SCD offers a 10³-10⁴ reduction in energy consumption during the drying step. Any unreacted silicic acid in smaller pores consolidates during SCD, resulting in a scaffold with reasonable mechanical strength. The strength provided by SCD generally does not exceed that provided by calcination. However, calcination of a microstructured product causes significant pore collapse, severely inhibiting function as a liquid flow device.^{31,33} Supercritical drying allows handling the product without damage and yields improved freeze-cast siliceous products for liquid flow applications¹⁰ relative to freeze drying and calcination.

### Mechanical Properties

Young's modulus and yield strength support the claim that three-molar scaffolds have sufficiently consolidated walls (FIGS. 8b and 5). Under uniaxial compressive stress, the three-molar scaffold has a superior average Young's modulus of 455±34 kPa and yield strength of 215±10 kPa compared with one- and two-molar scaffolds. Freeze-cast glassy and ceramic-like materials demonstrate brittle intergranular fracture under compressive stress with relatively high Young's moduli.^{34,35} To our knowledge, no other purely silica scaffold (Table 2) with highly anisotropic porosity reported is stronger under compression without calcination, which regularly increases Young's modulus from the order of 10³-10⁵ to 10⁶-10⁹ Pa.^{9,25} Organic additives can increase the durability of freeze-cast materials (Table 1).^{10,25,36} However, for applications involving harsh chemicals or irradiation, organic additives compromise the corrosion- and UV-resistance of the substrate. The ability to withstand harsh chemicals, UV irradiation, and moderate handling are often key factors in whether microreactors can be implemented outside of a laboratory setting.

TABLE 2
Mechanical Properties of Freeze-Cast Silica Monoliths^{a}

| | | Young's modulus | Yield strength | |
|---|---|---|---|---|
| inorganic/ | | in compression | in compression | |
| Organic | Description of material | (kPa) | (kPa) | Reference |
| purely inorganic | robust, reproducible silica scaffold | 455 ± 34 | 215 ± 10 | this report |
| purely inorganic | titania-silica “microhoneycomb” | not reported | 40 | 4 |
| purely inorganic | macroporous silica “microhoneycomb” | not reported | 100 | 37 |
| organic additive | silica-silk fibroin bioaerogel “silica-SF-10-66” | 424,000 | 360 | 10 |
| organic additive | macroporous silica scaffold with organic linkages | 27 ± 0.7 | not reported | 23 |
| organic additive | soft silica scaffold with organic linkages | 24 | not reported | 25 |

^{a}Among purely inorganic silica-based anisotropic scaffolds, this report contains the most mechanically robust product. While organic additives can reinforce scaffold walls and provide increased mechanical strength, incorporation of organics can also lead to scaffold degradation depending upon the desired application or functionalization.

### Pore Sizes Ideal for Liquid Flow

Pore anisotropy and diameter are controlled during synthesis to produce scaffolds that facilitate liquid flux at low head pressures. For scaffolds with 10-100 μm pore diameters, we estimate Laplace pressures of 0.03-0.28 atm. Pores on the order of tens of microns allow scaffolds to endure liquid flow without destructive pore rupture, unlike glassy materials with pores smaller than three microns. Experimentally, scaffolds synthesized by this method can sustain 3.5±1.0 mL min⁻¹ cm⁻² volumetric flux of water with 4.4 kPa head pressure (FIG. 9) and can likely sustain relatively faster rates and higher head pressures without device damage; flux is linearly dependent on applied head pressure. Anisotropic scaffold macropores with an equivalent diameter of 47 μm at these three head pressures result in an estimated Reynolds number less than 0.02 for water. This small Reynolds number indicates laminar flow, which reduces strain on pore walls. With laminar flow, the estimated diffusion time for solute molecules to travel from the center of the pore to a scaffold wall is on the order of milliseconds. This allows sufficient time for multiple interactions between liquid-phase moieties and functionalized scaffold walls during transit.

FIG. 10 shows the water flow rate as a function of time at 1.47 kPa constant head pressure. The flow rate remains nearly constant with time indicating that the pore structure is robust—neither collapsing nor clogging—with time.

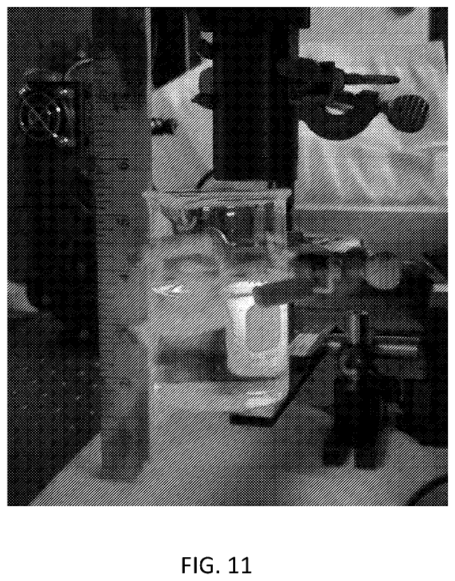

Anisotropic pores in the ice-templated scaffold allow for lower-pressure, higher-volume liquid flow than spongy materials with torturous liquid paths despite similar pore sizes.^{23,38} This silica scaffold has flow capabilities and head pressures similar to those reported for other anisotropic microreactors.⁴ The flow capabilities of this scaffold enable its use in combination batch-flow applications or in continuous flow settings, and its translucency is useful in applications where adsorbed moieties are activated by visible or UV light (See Example 2, FIGS. 11 and 12).

### Example 1 References

(1) Rouquerol, J.; Avnir, D.; Fairbridge, C. W.; Everett, D. H.; Haynes, J. M.; Pernicone, N.; Ramsay, J. D.; Sing, K. S.; Unger, K. K. Recommendations for the Characterization of Porous Solids (Technical Report). Pure Appl. Chem. 1994, 66, 1739-1758.
(2) Velev, O. D.; Jede, T. A.; Lobo, R. F.; Lenhoff, A. M. Porous Silica via Colloidal Crystallization. Nature 1997, 389, 447-448.
(3) Sachse, A.; Galarneau, A.; Fajula, F.; Di Renzo, F.; Creux, P.; Coq, B. Functional Silica Monoliths with Hierarchical Uniform Porosity as Continuous Flow Catalytic Reactors. Microporous Mesoporous Mater. 2011, 140, 58-68.
(4) Urkasame, K.; Yoshida, S.; Takanohashi, T.; Iwamura, S.; Ogino, I.; Mukai, S. R. Development of TiO2-SiO2 Photocatalysts Having a Microhoneycomb Structure by the Ice Templating Method. ACS Omega 2018, 3, 14274-14279.
(5) Buga, M.-R.; Spinu-Zaulet, A. A.; Ungureanu, C. G.; Mitran, R.-A.; Vasile, E.; Florea, M.; Neatu, F. Carbon-Coated SiO2 Composites as Promising Anode Material for Li-Ion Batteries. Molecules 2021, 26, 4531.
(6) Poryvaev, A. S.; Gjuzi, E.; Yazikova, A. A.; Polyukhov, D. M.; Albrekht, Y. N.; Efremov, A. A.; Kudriavykh, N. A.; Yanshole, V. V.; Hoffmann, F.; Fröba, M.; Fedin, M. V. Blatter Radical-Decorated Silica as a Prospective Adsorbent for Selective NO Capture from Air. ACS Appl. Mater. Interfaces 2023, 15, 5191-5197.
(7) Su, X. D.; Tao, J.; Chen, S.; Xu, P.; Wang, D.; Teng, Z. G. Uniform Hierarchical Silica Film with Perpendicular Macroporous Channels and Accessible Ordered Mesopores for Biomolecule Separation. Chin. Chem. Lett. 2019, 30, 1089-1092.
(8) Zhao, D.; Feng, J.; Huo, Q.; Melosh, N.; Fredrickson, G. H.; Chmelka, B. F.; Stucky, G. D. Triblock Copolymer Syntheses of Mesoporous Silica with Periodic 50 to 300 Angstrom Pores. Science 1998, 279, 548-552.
(9) Choi, Y.; Jeong, J. H.; Kim, J. Mechanically Enhanced Hierarchically Porous Scaffold Composed of Mesoporous Silica for Host Immune Cell Recruitment. Adv. Healthcare Mater. 2017, 6, No. 1601160.
(10) Maleki, H.; Shahbazi, M.-A.; Montes, S.; Hosseini, S. H.; Eskandari, M. R.; Zaunschirm, S.; Verwanger, T.; Mathur, S.; Milow, B.; Krammer, B.; Hüsing, N. Mechanically Strong Silica-Silk Fibroin Bioaerogel: A Hybrid Scaffold with Ordered Honeycomb Micro-morphology and Multiscale Porosity for Bone Regeneration. ACS Appl. Mater. Interfaces 2019, 11, 17256-17269.
(11) Iqbal, M. N.; Robert-Nicoud, G.; Ciurans-Oset, M.; Akhtar, F.; Hedin, N.; Bengtsson, T. Mesoporous Silica Particles Retain Their Structure and Function while Passing through the Gastrointestinal Tracts of Mice and Humans. ACS Appl. Mater. Interfaces 2023, 15, 9542-9553.
(12) Wang, D. Y.; Caruso, R. A.; Caruso, F. Synthesis of Macroporous Titania and Inorganic Composite Materials from Coated Colloidal Spheres-A Novel Route to Tune Pore Morphology. Chem. Mater. 2001, 13, 364-371.
(13) Zanardo, D.; Forghieri, G.; Tieuli, S.; Ghedini, E.; Menegazzo, F.; Di Michele, A.; Cruciani, G.; Signoretto, M. Effects of SiO2-Based Scaffolds in TiO2 Photocatalyzed CO2 Reduction. Catal. Today 2022,387, 54-60.
(14) Tillotson, T. M.; Hrubesh, L. W. Transparent Ultralow-Density Silica Aerogels Prepared by a Two-Step Sol-Gel Process. J. Non-Cryst. Solids 1992, 145, 44-50.
(15) Zhao, L.; Bhatia, B.; Yang, S.; Strobach, E.; Weinstein, L. A.; Cooper, T. A.; Chen, G.; Wang, E. N. Harnessing Heat Beyond 200° C. from Unconcentrated Sunlight with Nonevacuated Transparent Aerogels. ACS Nano 2019, 13, 7508-7516.
(16) Hubadillah, S. K.; Othman, M. H. D.; Matsuura, T.; Rahman, M. A.; Jaafar, J.; Ismail, A. F.; Amin, S. Z. M. Green Silica-Based Ceramic Hollow Fiber Membrane for Seawater Desalination via Direct Contact Membrane Distillation. Sep. Purif. Technol. 2018, 205, 22-31.
(17) Jaisingh, A.; Goel, V.; Kapur, G. S.; Nebhani, L. Reactive Compatibilization of Impact Copolymer Polypropylene and Organ-ically Modified Mesoporous Silica to Prepare Composites Possessing Enhanced Mechanical Properties. ACS Appl. Eng. Mater. 2023, 1, 877-893.
(18) Kim, J.-W.; Tazumi, K.; Okaji, R.; Ohshima, M. Honeycomb Monolith-Structured Silica with Highly Ordered, Three-Dimension-ally Interconnected Macroporous Walls. Chem. Mater. 2009, 21, 3476-3478.
(19) Mukai, S. R.; Nishihara, H.; Tamon, H. Porous Properties of Silica Gels with Controlled Morphology Synthesized by Unidirec-tional Freeze-Gelation. Microporous Mesoporous Mater. 2003, 63, 43-51.
(20) Nishihara, H.; Mukai, S. R.; Yamashita, D.; Tamon, H. Ordered Macroporous Silica by Ice Templating. Chem. Mater. 2005, 17, 683-689.
(21) Suh, D. J.; Park, T. J.; Han, H. Y.; Lim, J. C. Synthesis of High-Surface-Area Zirconia Aerogels with a Well-Developed Mesoporous Texture Using CO2 1452-1454. Supercritical Drying. Chem. Mater. 2002, 14,
(22) Deville, S.; Saiz, E.; Nalla, R. K.; Tomsia, A. P. Freezing as a Path to Build Complex Composites. Science 2006, 311, 515-518.
(23) Chatterjee, S.; Potdar, A.; Kuhn, S.; Kumaraswamy, G. Preparation of Macroporous Scaffolds with Holes in Pore Walls and Pressure Driven Flows through Them. RSC Adv. 2018, 8, 24731-24739.
(24) Nishihara, H.; Mukai, S. R.; Shichi, S.; Tamon, H. Preparation of titania-silica cryogels with controlled shapes and photocatalysis through unidirectional freezing. Mater. Lett. 2010, 64, 959-961.
(25) Rajamanickam, R.; Kumari, S.; Kumar, D.; Ghosh, S.; Kim, J. C.; Tae, G.; Sen Gupta, S.; Kumaraswamy, G. Soft Colloidal Scaffolds Capable of Elastic Recovery after Large Compressive Strains. Chem. Mater. 2014, 26, 5161-5168.
(26) Zhang, H.; Hussain, I.; Brust, M.; Butler, M. F.; Rannard, S. P.; Cooper, A. I. Aligned Two- and Three-Dimensional Structures by Directional Freezing of Polymers and Nanoparticles. Nat. Mater. 2005, 4, 787-793.
(27) Genov, G. Device for Measuring Stress-Strain Curves of Soft Materials: A Poor Man's Solution 2018.
(28) Brinker, C. J. Hydrolysis and Condensation of Silicates: Effects on Structure. J. Non-Cryst. Solids 1988, 100, 31-50.
(29) Iler, R. K. 4. Colloidal Silica-Concentrated Sols. In Chemistry of Silica-Solubility, Polymerization, Colloid and Surface Properties and Biochemistry; John Wiley & Sons, 1979; pp 375-378.
(30) Nelson, I.; Naleway, S. E. Intrinsic and Extrinsic Control of Freeze Casting. J. Mater. Res. Technol. 2019, 8, 2372-2385.
(31) García-González, C.; Camino-Rey, M. C.; Alnaief, M.; Zetzl, C.; Smirnova, I. Supercritical Drying of Aerogels Using CO2: Effect of Extraction Time on the End Material Textural Properties. J. Supercrit. Fluids 2012, 66, 297-306.
(32) Chao, C.; Xu, X.; Kwelle, S. O.; Fan, X. Significance of Gas-Liquid Interfaces for Two-Phase Flows in Micro-Channels. Chem. Eng. Sci. 2018, 192, 114-125.
(33) Putz, F.; Waag, A.; Balzer, C.; Braxmeier, S.; Elsaesser, M. S.; Ludescher, L.; Paris, O.; Malfait, W. J.; Reichenauer, G.; Hüsing, N. The Influence of Drying and Calcination on Surface Chemistry, Pore Structure and Mechanical Properties of Hierarchically Organized Porous Silica Monoliths. Microporous Mesoporous Mater. 2019, 288, No. 109578.
(34) Liu, H.; Li, L.; Li, J.; Guo, A.; Hu, X.; Du, H. Mechanical Response and Failure Behavior of Fiber Enforced Porous Ceramics by Directional Freeze-Casting. Ceram. Int. 2021, 47, 8593-8600.
(35) Seuba, J.; Deville, S.; Guizard, C.; Stevenson, A. J. Mechanical Properties and Failure Behavior of Unidirectional Porous Ceramics. Sci. Rep. 2016, 6, No. 24326.
(36) Loy, D. A.; Russick, E. M.; Yamanaka, S. A.; Baugher, B. M.; Shea, K. J. Direct Formation of Aerogels by Sol-Gel Polymerizations of Alkoxysilanes in Supercritical Carbon Dioxide. Chem. Mater. 1997, 9, 2264-2268.
(37) Mukai, S. R.; Onodera, K.; Yamada, I. Studies on the Growth of Ice Crystal Templates During the Synthesis of a Monolithic Silica Microhoneycomb Using the Ice Templating Method. Adsorption 2011, 17, 49-54.
(38) Vanson, J.-M.; Boutin, A.; Klotz, M.; Coudert, F.-X. Transport and Adsorption Under Liquid Flow: the Role of Pore Geometry. Soft Matter 2017, 13, 875-885.

### Example 2

Transmittance Measurements and Scaffold Optical Properties. Single-wavelength radiation sources at 633 nm (He—Ne laser), 532 nm (diode), and 405 nm (diode) were used to measure transmittance through three-molar scaffolds, top-to-bottom (FIG. 12). Qualitatively, the silica scaffold has good translucency along the length of the pores. Transmittance measurements at three discrete wavelengths yielded less than one percent transmission, yet transmittance of light through the scaffold improves in water compared to air at all wavelengths (FIG. 13). This indicates that the scaffold's index of refraction is closer to that of water than that of air, consistent with other anisotropic porous siliceous materials.¹

For scaffolds generated by this method, poor transmittance is likely due (in part) to silicate precursor oligomer clumps which cause optical defects within the consolidated pore walls. Dynamic light scattering data (FIG. 3) reveal a solution where most oligomers are 1.8±0.9 nm in hydrodynamic diameter. However, significant amounts of larger, sedimenting particles are also present in the sodium metasilicate solution at 530±160 nm and 5.0±0.6 μm size. These preexisting particles likely cause more scattering than would be observed if a scaffold was prepared from a purely monomeric solution; during freeze-casting these oligomers are confined to the grain boundary and likely become included in pore walls as optical defects. Divergence from the laser and diode light sources as the beam passes through the length of the scaffold (FIG. 11) is also a likely contributor to poor transmittance outcomes. Despite low transmission, the translucency of the silica scaffold remains useful in applications where adsorbed moieties are activated by visible and UV light.

Among quantitative measures of light transmittance through anisotropically macroporous inorganic materials, five percent transmittance at visible wavelengths is the highest reported.¹ Macroporous silicas prepared by freeze casting have not yet approached the transparency of reported mesoporous silica aerogels, which often exceed 90 percent transparency at visible wavelengths.^{2,3}

### Example 2 References

(1) Urkasame, K.; Yoshida, S.; Takanohashi, T.; Iwamura, S.; Ogino, I.; Mukai, S. R. Development of TiO2-SiO2 Photocatalysts Having a Microhoneycomb Structure by the Ice Templating Method. ACS Omega 2018, 3, 14274-14279. DOI: 10.1021/acsomega.8b01880.
(2) Zhao, L.; Bhatia, B.; Yang, S.; Strobach, E.; Weinstein, L. A.; Cooper, T. A.; Chen, G.; Wang, E. N. Harnessing Heat Beyond 200° C. from Unconcentrated Sunlight with Nonevacuated Transparent Aerogels. ACS Nano 2019, 13, 7508-7516. DOI: 10.1021/acsnano.9b02976.
(3) Du, A.; Wang, H.; Zhou, B.; Zhang, C.; Wu, X.; Ge, Y.; Niu, T.; Ji, X.; Zhang, T.; Zhang, Z.; Wu, G.; Shen, J. Multifunctional Silica Nanotube Aerogels Inspired by Polar Bear Hair for Light Management and Thermal Insulation. Chem. Mater. 2018, 30, 6849-6857. DOI: 10.1021/acs.chemmater.8b02926.

1. A silica scaffold comprising:
a unidirectional, micron-pore, silica honeycomb monolith, wherein the unidirectional, micron-pore, silica honeycomb monolith has unidirectional pores having a length of at least 20 mm, a pore cross-sectional dimension of between 1 μm and 100 μm, and a pore wall thickness of between 10 nm and 1000 nm or between 1 μm and 20 μm.

2. The silica scaffold of claim 1, wherein the unidirectional, micron-pore, silica honeycomb monolith has a Young's modulus of 300 kPa or greater.

3. The silica scaffold of claim 1, wherein the unidirectional, micron-pore, silica honeycomb monolith has a yield strength of 100 kPa or greater.

4. The silica scaffold of claim 1, wherein the unidirectional, micron-pore, silica honeycomb monolith has a water-flow-through rate of 1 mL/min·cm² or greater.

5. The silica scaffold of claim 1, wherein the unidirectional, micron-pore, silica honeycomb monolith has a water-flow-through rate of 1 mL/min·cm² or greater with a constant head pressure of about 1.5 kPa.

6. The silica scaffold of claim 1, wherein the unidirectional, micron-pore, silica honeycomb monolith has a water-flow-through rate of 2 mL/min·cm² or greater with a constant head pressure of about 2.7 kPa.

7. The silica scaffold of claim 1, wherein the unidirectional, micron-pore, silica honeycomb monolith has a water-flow-through rate of 3 mL/min·cm² or greater with a constant head pressure of about 4.4 kPa.

8. The silica scaffold of claim 1, wherein the unidirectional, micron-pore, silica honeycomb monolith when submerged in water has an optical transmittance at one or more ultraviolet or visible wavelengths of at least 0.5% or at least 5%.

9. The silica scaffold of claim 1, wherein the unidirectional pores have an average cross-sectional aspect ratio of between 1:1 and 10:1.

10. The silica scaffold of claim 1, wherein the unidirectional pores have a length of at least 1 cm.

11. The silica scaffold of claim 1, wherein the pore cross-sectional dimension is between 25 μm and 75 μm.

12. A method of making a silica scaffold comprising a unidirectional, micron-pore, silica honeycomb monolith, the method comprising:
freeze-casting a silicic acid solution having a pH of between 0 and 6 and a concentration of silicic acid of at least 1 M, thereby providing a freeze-casted article; and
supercritically drying the freeze-casted article, thereby providing the unidirectional, micron-pore, silica honeycomb monolith, wherein the unidirectional, micron-pore, silica honeycomb monolith optionally has unidirectional pores having a length of at least 20 mm up to 500 mm, a pore cross-sectional dimension of between 1 μm and 100 μm, and a pore wall thickness of between 10 nm and 1000 nm or between 1 μm and 20 μm.

13. The method of claim 12, wherein the unidirectional, micron-pore, silica honeycomb monolith has unidirectional pores having a length of at least 10 mm up to 500 mm, a pore cross-sectional dimension-of between 1 μm and 100 μm, or a pore wall thickness of between 1 μm and 20 μm.

14. The method of claim 12, wherein the supercritical drying includes submerging the freeze-casted article in a volatile solvent for a predetermined soaking length of time, thereby providing a soaked, freeze-casted article.

15. The method of claim 14, wherein the supercritical drying further comprises heating the soaked, freeze-casted article above a critical point of the volatile solvent.

16. The method of claim 14, wherein the volatile solvent is ethanol.

17. The method of claim 12, wherein the unidirectional, micron-pore, silica honeycomb monolith has a Young's modulus of 300 kPa or greater.

18. The method of claim 12, wherein the unidirectional, micron-pore, silica honeycomb monolith has a yield strength of 100 kPa or greater.

19. The method of claim 12, wherein the unidirectional, micron-pore, silica honeycomb monolith has a water-flow-through rate of 1 mL/min·cm² or greater.

20. The method of claim 12, wherein the unidirectional, micron-pore, silica honeycomb monolith when submerged in water has an optical transmittance at one or more ultraviolet or visible wavelengths of at least 0.5% or at least 5%.

21. The method of claim 12, wherein the unidirectional pores have an average cross-sectional aspect ratio of between 1:1 and 10:1.

22. The method of claim 12, wherein the unidirectional pores have a length of at least 1 cm.

23. The method of claim 12, wherein the pore cross-sectional dimension is between 25 μm and 75 μm.
